(19) United States
(12) Patent Application Publication
(10) Pub. No.: US 2002/0069006 A1
(43) Pub. Date: Jun. 6, 2002

(54) Device and method for stabilizing a vehicle

(76) Inventors: Ian Faye, Stuttgart (DE); Walfgang Kraemer, Ingolstadt (DE)

Correspondence Address: KENYON & KENYON, ONE BROADWAY, NEW YORK, NY, 10004, US

(21) Appl. No.: 09/899,602

(22) Filed: Jul. 5, 2001

(30) Foreign Application Priority Data
Jul. 4, 2000 (DE) 100 31 849.5

(51) Int. Cl. B62D 53/00

(52) U.S. Cl. 701/70; 280/400

(57) ABSTRACT

A device for stabilizing a vehicle is described. The device contains a first determining arrangement using which at least one vehicle motion quantity is determined. Furthermore, the device contains a second determining arrangement using which a characteristic quantity is determined for the vehicle motion quantity. In addition, the device contains a control arrangement using which intervention quantities are determined as a function of the vehicle motion quantity and the characteristic quantity and are supplied to an actuator arrangement to perform brake interventions and/or engine interventions in order to stabilize the vehicle. The second determining arrangement contains a computing arrangement using which a final value for the characteristic quantity is determined and is supplied to the adjusting arrangement using which the variation over time according to which the characteristic quantity attains its final value is adjusted to the behavior of the vehicle. The variation over time is determined using a stored characteristic map or a stored table.

### FIELD OF THE INVENTION

The present invention relates to a device and a method for stabilizing a vehicle. Such devices and methods are known from the related art in a plurality of versions.

### BACKGROUND INFORMATION

SAE paper 973284 “Vehicle Dynamics Control for Commercial Vehicles” describes a device for stabilizing a commercial vehicle designed as a tractor-trailer composed of a tractor vehicle and a semi-trailer. The float angle and the yaw rate of the tractor vehicle and the buckling angle between the tractor vehicle and the semi-trailer are controlled with this device. For this purpose, a system deviation between the actual values and the setpoint values of the float angle, the yaw rate, and the buckling angle are determined. Engine interventions and/or brake interventions are performed as a function of these system deviations to stabilize the tractortrailer.

The article published in the journal “Automobiltechnische Zeitschrift” (ATZ) [Journal of Automotive Technology] 96, 1994, Vol.11, pp.674-689, “FDR—Die Fahrdynamikregelung von Bosch” [FDR—Vehicle Dynamics Control by Bosch] describes such a stabilization device for passenger vehicles. In this stabilization device only the yaw rate and the float angle of the vehicle are taken into consideration for control.

The contents of the two above-mentioned documents is to be part of the description that follows.

German Published Patent Application No. 198 59 966 also describes a method and a device for stabilizing a vehicle. The device described in this document contains a first determining arrangement using which at least two vehicle motion quantities describing the motion of the vehicle are determined. Furthermore, the device contains a second determining arrangement using which a characteristic quantity is determined for each of the vehicle motion quantities. The second determining arrangement contains an adjusting arrangement, using which the variation of the characteristic quantities over time is adjusted to the behavior of the vehicle. Intervention quantities are determined as a function of the vehicle motion quantities and the characteristic quantities and are supplied to an actuator arrangement for carrying out brake interventions and/or engine interventions to stabilize the vehicle.

None of the above documents indicates that the variation of the characteristic quantity over time can be determined using a stored characteristic map or table.

Against this background, the object of the present invention is to provide a device and a method for stabilizing a vehicle in which the variation of the characteristic quantity over time is adjusted to the vehicle's behavior in a simple manner without a high computing capacity requirement.

### SUMMARY OF THE INVENTION

The present invention has the following background: If the driver of a vehicle performs a steering motion, a certain time elapses before the vehicle follows this steering motion and performs the desired turn, i.e., assumes the steady state initialized by the steering motion. If now the setpoint values are determined via appropriate vehicle models which describe the steady state as a function of the steering angle without time adjustment, the values of the steady state are available for the setpoint values from the beginning. However, since the instantaneous actual state of the vehicle, at least immediately after the steering motion is initiated, does not yet correspond to the steady state, a system deviation is present, which incorrectly results in unneeded control interventions, which would not be made if an adjustment of the variations of the setpoint values over time was made to the behavior of the vehicle.

This effect is particularly noticeable in the case of commercial vehicles. In the control of commercial vehicles, particular attention must be paid to the behavior of the vehicle in space due to the variable load conditions and the high and highly variable position of the center of gravity.

The device according to the present invention contains a first determining arrangement using which at least one vehicle motion quantity which describes the motion of the vehicle, in particular in the vehicle transverse direction, is determined. This at least one vehicle motion quantity corresponds to one of the actual values mentioned previously. In addition, the device contains a second determining arrangement using which a characteristic quantity is determined for the at least one vehicle motion quantity. The characteristic quantity corresponds to the above-mentioned setpoint and describes the vehicle behavior intended by the driver. Furthermore, there is control arrangement using which intervention quantities are determined as a function of the at least one vehicle motion quantity and the characteristic quantity. These intervention quantities are supplied to an actuator arrangement to perform brake interventions and/or engine interventions in order to stabilize the vehicle.

The second determining arrangement contains a computing arrangement using which a final value for the at least one characteristic quantity is determined and is supplied to the adjusting arrangement located in the second determining arrangement. Using the adjusting arrangement the variation over time according to which the characteristic quantity attains its final value is adjusted to the behavior of the vehicle.

For the variation of the characteristic quantity over time to be adjusted to the behavior of the vehicle in a simple manner without a high computing capacity requirement, the variation of the characteristic quantity over time is advantageously determined according to the present invention using a stored characteristic map or a stored table.

The adjusting arrangement is advantageously designed as a filter arrangement, in particular as low-pass filters or all-pass filters or as a PT1 element, using which the variation of the characteristic quantity over time can be influenced by specifying a filter constant.

It has been found particularly advantageous if an all-pass filter is used as the filter arrangement. The phase and thus the variation of the characteristic quantity over time can be modified with the aid of an all-pass filter without modifying the value, i.e., the amplitude, of the characteristic quantity. The same holds true if a low-pass filter having a very low limit frequency is used as the filter arrangement.

The value of the filter constant is advantageously read from the stored characteristic map or the stored table as a function of a mass quantity, which describes the mass of the vehicle, and/or a velocity quantity, which describes the velocity of the vehicle. The velocity of the vehicle is advantageously the velocity of the tractor vehicle.

By reading the filter constant from the stored characteristic map or the stored table, the variation of the characteristic quantity over time is adjusted to the behavior of the vehicle in a simple manner and, primarily, without a high computing capacity requirement. The value does not have to be recalculated every time. Instead, different values for the filter constant are determined in advance by test drives, so that the required filter constant has to be merely read out during the operation of the vehicle.

The final value is advantageously determined at least as a function of a steering angle quantity, which describes the steering angle set for the vehicle, and a velocity quantity, which describes the velocity of the vehicle. The steering angle quantity represents the driver's intent and the velocity quantity represents the state of the vehicle. The final value corresponds to the value of the vehicle motion quantity prevailing in a steady state of the vehicle.

The final value is advantageously determined using a vehicle model, with some of the parameters used in this vehicle model being determined at least as a function of vehicle quantities and/or vehicle parameters. The steering angle and the vehicle velocity are supplied to the vehicle model as input quantities.

In determining the parameters used in the vehicle model, at least one mass quantity and/or at least one center of gravity position quantity are advantageously used as vehicle quantities. This additionally ensures that in determining the characteristic quantities, the influence of different load conditions is taken into account, i.e., changes in the condition of the vehicle are recognized and taken into account in the control. In the case of a tractor-trailer, a mass quantity and/or a center of gravity position quantity is advantageously determined both for the tractor and the trailer. Geometry parameters and/or tire rigidity quantities are used as vehicle parameters, since both also have a non-negligible influence on the behavior of the vehicle.

The variation of the characteristic quantity over time is advantageously adjusted to the behavior of the vehicle using the adjusting arrangement so that the characteristic quantity attains its final value only after a predefined period of time that is characteristic for the vehicle.

The device according to the present invention can be used for both single vehicles and tractortrailers. If the vehicle is a tractor-trailer unit having a tractor vehicle and a trailer or semitrailer, three vehicle motion quantities are determined in this case using the first determining arrangement. Two of these vehicle motion quantities describe the behavior of the tractor vehicle and one of these vehicle motion quantities describes the position and/or the behavior of the trailer or semi-trailer with respect to the tractor vehicle. Specifically in this case a yaw rate quantity which describes the yaw rate of the tractor vehicle is determined as a first vehicle motion quantity, and/or a float angle quantity which describes the float angle of the tractor vehicle is determined as a second vehicle motion quantity, and/or a buckling angle quantity which describes the buckling angle between the tractor vehicle and the trailer or semi-trailer is determined as a third vehicle motion quantity. The tractor-trailer can be stabilized by controlling these three vehicle motion quantities.

If the vehicle is a single vehicle, a yaw rate quantity which describes the yaw rate of the single vehicle is determined as a first vehicle motion quantity, and/or a float angle quantity which describes the float angle of the single vehicle is determined as a second vehicle motion quantity. The single vehicle can be stabilized by controlling these two vehicle motion quantities.

If a plurality of vehicle motion quantities with their respective characteristic quantities are determined, two methods can be used for adjusting the variations of the characteristic quantities over time. The variations of all characteristic quantities over time can be adjusted to the vehicle's behavior in the same manner using the adjusting arrangement. In this case, the time period after which the characteristic quantities attain their final value is the same for all characteristic quantities. This method can be used if the vehicle exhibits the same behavior over time for all vehicle motion quantities for which control is performed, as far as assuming their steady-state value is concerned. Another method is adjusting the variation of each individual characteristic quantity over time to the vehicle's behavior separately using the adjusting arrangement. In this case the time period for each characteristic quantity is different. This method is required if the vehicle exhibits different behaviors over time for the vehicle motion quantities for which control is performed.

If a plurality of vehicle motion quantities with their respective characteristic quantities are determined, value limitation is performed for at least some of the respective final values. This limitation is advantageously performed as a function of a transverse acceleration quantity and/or a longitudinal acceleration quantity which describes the transverse and/or longitudinal acceleration acting on the vehicle, or as a function of a friction coefficient quantity or as a function of wheel force quantities which describe the forces acting on the wheels of the vehicle.

The float angle of a vehicle is defined as follows: the float angle of a vehicle is the angle between the direction of the vehicle velocity at the center of gravity of the vehicle, i.e., the direction of motion of the vehicle, and the longitudinal axis of the vehicle.

In addition to the above-mentioned brake and engine interventions, interventions in the chassis or in the transmission or interventions using a retarder can also be advantageously applied to stabilize the vehicle.

It should be pointed out again here: in general, in the method implemented by the device according to the present invention, a setpoint value for the motion quantity to be controlled is initially determined using a vehicle model based on the steering angle, which represents the driver's intent, and the vehicle velocity which represents the vehicle's condition. If the underlying control is a vehicle dynamics control using which the yaw rate of the vehicle is controlled, the setpoint for the yaw rate is determined in this case. The vehicle model represents a static relationship between the steering angle and the setpoint value for the motion quantity to be controlled. In order to take the vehicle dynamics into account when computing the setpoint value, a PT1 element is connected downstream from the setpoint value generator; the setpoint is processed using this PT1 element. This setpoint processing is implemented as driving status dependent or vehicle status dependent filtering. In this filtering the PT1 element is set on a physical basis, allowing more accurate and more targeted control measures to be taken. The time constant of the PT1 element is adjusted on the basis of the vehicle status. This implementation facilitates system application.

By adjusting the filter constant of the filter arrangement to the vehicle's behavior according to the present invention, adjustments of the response thresholds for the control, which were previously required to avoid stabilization measures based on the above-mentioned deviation of the setpoint due to the model, are no longer needed. This means that the response thresholds can be selected to be lower, which results in more accurate underlying control.

### BRIEF DESCRIPTION OF THE DRAWINGS

FIG. 1 shows a tractor-trailer in which the device according to the present invention is used.

FIG. 2 shows a control structure on which the present invention is based.

### DETAILED DESCRIPTION

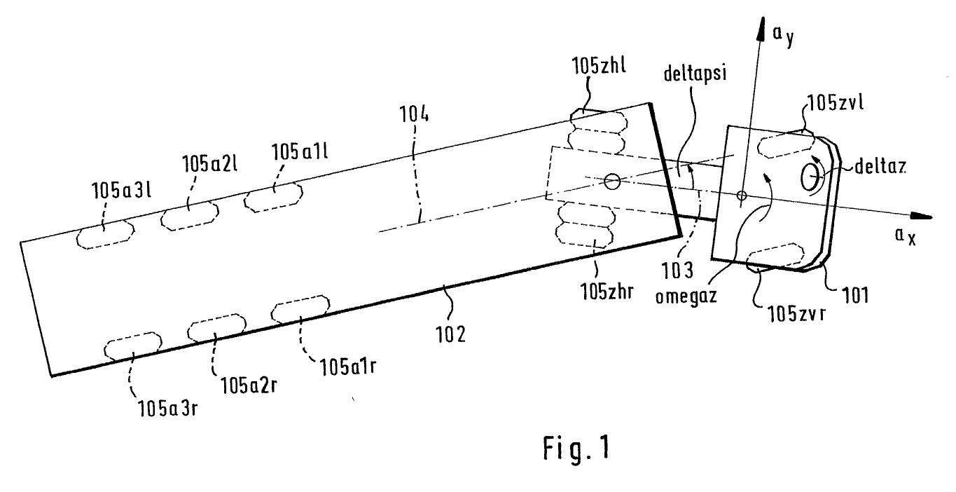

FIG. 1 shows a tractor-trailer including a tractor vehicle 101 and a semi-trailer 102. Tractor vehicle 101 and semi-trailer 102 are mechanically linked by a rotating joint, usually a kingpin, not illustrated.

The embodiment is based on a tractor-trailer having a semi-trailer unit. This should not represent any restriction. The device according to the present invention may correspondingly also be used for a tractor-trailer having a tractor and a draw bar trailer or a passenger car and a trailer or a motor home. The device according to the present invention can also be correspondingly used for a single vehicle, which may be a commercial vehicle or a passenger vehicle.

Tractor vehicle 101 has wheels 105zij, whose actuators are associated with the performance of brake interventions. In the notation 105zij index z indicates that the wheels belong to the tractor vehicle. Index i indicates whether reference is made to a front axle (v) or a rear axle (h). Index j indicates whether reference is made to a right-side (r) or a left-side (l) vehicle wheel. Trailer 102 has wheels 105axj. Index a indicates that reference is being made to the wheels of the semi-trailer. Index x indicates the axle of the semi-trailer to which the respective wheel belongs. Components, for which indices a, i, j, x, and z are used, have the same meaning.

FIG. 1 shows a longitudinal axis 103 of the tractor vehicle. Longitudinal axis 104 of the semi-trailer is similarly shown. As FIG. 1 shows, two longitudinal axes 103 and 104 form an angle deltapsi, which is referred to as the buckling angle. According to the amount by which the semi-trailer is deflected with respect to the tractor vehicle, buckling angle deltapsi has different values.

FIG. 1 also shows the quantities describing the travel characteristics of the tractor vehicle such as longitudinal acceleration ax, transverse acceleration ay, yaw rate omegaz and steering angle deltaz set for the tractor vehicle.

The following should be pointed out here concerning the control principle: if the vehicle is a tractor-trailer unit, the yaw rate and the float angle of the tractor and the buckling angle between the tractor vehicle and the trailer or semi-trailer are usually controlled to stabilize the vehicle. Optionally, the yaw rate of the semi-trailer or trailer can also be controlled. If the vehicle is a single vehicle, the yaw rate and the float angle of this single vehicle are usually controlled.

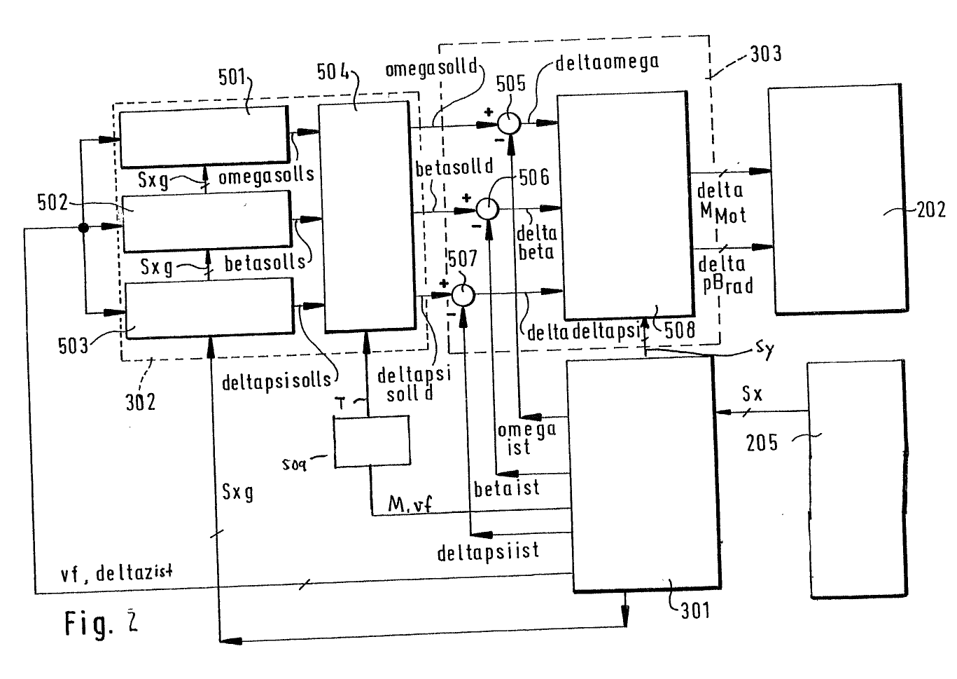

In the following, FIG. 2 is explained in detail.

FIG. 2 shows a block 205, which is the sensor system contained in the vehicle. Block 205 includes sensors using which the vehicle's behavior is determined. Yaw rate omegaz of the tractor vehicle is determined using a yaw rate sensor; transverse acceleration ay of the tractor vehicle is determined using a transverse acceleration sensor; wheel speeds vrad for both the tractor vehicle wheels and the semi-trailer wheels are determined using wheel speed sensors, and buckling angle deltapsi is determined using appropriate an sensor arrangement. Longitudinal acceleration ax of the tractor vehicle can be determined either in the known manner from the wheel speeds or using appropriate acceleration sensors. Variable vrad used above for the wheel speeds includes the speeds of wheels 105zij and 105axj shown in FIG. 1.

Block 205 also includes sensors for detecting quantities set by the driver. The driver sets a steering angle deltaz by operating the steering wheel; he sets an engine torque MMot by pressing the gas pedal, and sets an admission pressure PB by pressing the brake pedal. The steering angle is detected using a steering angle sensor. The engine torque specified by the driver can be deduced from the gas pedal position, which is detected, for example, using a suitable path sensor or potentiometer. The admission pressure set by the driver is detected using a pressure sensor.

The individual quantities detected using block 205, which includes a plurality of individual sensors, are combined to form Sx and are supplied to a block 301. The two blocks 205 and 301 are referred to as a first determining arrangement.

Block 301 represents a signal processor which includes a filter arrangement and an estimating arrangement. At least some of the signals or quantities detected using sensor system 205 are processed using the filter arrangement. The signals or quantities are low-pass filtered to suppress noise. The filtered quantities are a vehicle motion quantity omegaist which describes the yaw rate of the tractor vehicle, a vehicle motion quantity deltapsiist which describes the buckling angle, and a steering angle quantity deltazist. The two vehicle motion quantities omegaist and deltapsiist are obtained by filtration from the respective quantities determined using the yaw rate sensor and the buckling angle sensor, respectively. Steering angle quantity deltazist is obtained by filtering from the quantity detected by the steering angle sensor. In addition, some of the signals and quantities are differentiated by appropriate filtering if required by the control principle.

Quantities that are required for performing the control or are taken into account in the control are determined using an estimating arrangement. These are the following quantities: mass quantities M describing the mass of the tractor vehicle and of the semi-trailer are determined.

The following method is used to determine the mass quantities. A total mass is determined for the tractor trailer on the basis of the wheel speeds and the propulsion force derived from the engine torque specified by the driver. Since the mass of the tractor vehicle is known in the case of a semi-trailer unit, the mass of the semi-trailer can be deduced. In the case of a tractor-trailer unit composed of a tractor vehicle and a draw bar trailer, the coupling force between tractor and draw bar trailer, as well as the longitudinal acceleration acting on the tractor-trailer unit, must be taken into account when determining the two individual masses. The coupling force can be determined either using an appropriate sensor or by an appropriate estimation method. As an alternative or additionally to the mass quantities, the moments of inertia for the tractor vehicle and the trailer can also be determined. For passenger vehicles no mass estimate is usually required.

Center of gravity position quantities which describe the position of the center of gravity for the tractor and the semi-trailer are determined. The two center of gravity position quantities can be determined from the wheel loads if the vehicle travels straight ahead, for example, and is neither accelerated nor braked. The wheel speeds are analyzed for determining the wheel loads.

Wheel force quantities describing the forces acting on the individual wheels are determined. Slip angle quantities describing the slip angle of the individual wheels are determined. The wheel force quantities and the slip angle quantities are determined at least as a function of the transverse acceleration, the yaw rate, the steering angle, and the vehicle velocity.

A velocity quantity vf describing the vehicle velocity in the longitudinal direction of the vehicle is determined. This velocity quantity vf is determined in a known manner from the wheel speeds. Furthermore, a velocity quantity vy describing the vehicle velocity in the vehicle transverse direction is determined. This velocity quantity can be determined by integrating the transverse acceleration.

A friction coefficient quantity describing the friction coefficient between the tires and the roadway is determined in appropriate driving situations. The friction coefficient quantity can be estimated as a function of the longitudinal acceleration, which is determined from the wheel velocities, and the transverse acceleration.

In addition, a float angle quantity betaist which describes the float angle of the tractor vehicle and which is required for control is determined. The float angle quantity is determined as a function of the vehicle transverse velocity, the vehicle longitudinal velocity and the yaw rate of the vehicle.

The three vehicle motion quantities omegaist, betaist, and deltapsiist are supplied to a controller 303. Specifically, quantity omegaist is supplied to a subtractor arrangement 505, quantity betaist is supplied to a subtractor arrangement 506, and quantity deltapsiist is supplied to a subtractor arrangement 507. These three vehicle motion quantities correspond to the actual values required for control.

Velocity quantity vf and steering angle quantity deltazist are supplied to a determining arrangement 302, more precisely, computing arrangements 501, 502, and 503.

In addition, quantities Sxg are supplied from block 301 to computing arrangements 501, 502, and 503. The individual quantities included in quantities Sxg will be described in detail below.

A mass quantity M, which describes the mass of both the tractor vehicle and the trailer or semi-trailer, and velocity quantity vf are supplied from block 301 to block 509. Block 509 represents a stored characteristic map or a stored table, using which the variation of the at least one characteristic quantity over time is determined. To do so, the value of a filter constant T is read from the characteristic map or table as a function of mass quantity M and velocity quantity vf. The value of filter constant T is supplied to a block 504, which represents an adjusting arrangement. Quantities Sy are supplied from block 301 to a block 508 which represents the control arrangement contained in controller 303. Quantities Sy are, for example, wheel force quantities, wheel speed quantities, the two velocity quantities vf and vy, a quantity describing the engine torque, a quantity describing the admission pressure set by the driver, a transverse acceleration quantity, a steering angle quantity, and a friction coefficient quantity.

A final value omegasolls for characteristic quantity omegasolld is determined in the determining arangement 501 as a function of velocity quantity vf and steering angle quantity deltazist supplied to it. For this purpose a vehicle model is stored in determining arrangement 501, for which velocity quantity vf and steering angle quantity deltazist represent the input quantities. Final value omegasolls is supplied to block 504.

A final value betasolls for characteristic quantity betasolld is similarly determined with the aid of determining arrangement 502 as a function of velocity quantity vf and steering angle quantity deltazist using a vehicle model, and a final value deltapsisolls for characteristic quantity deltapsisolld is determined with the aid of determining arrangement 503 as a function of velocity quantity vf and steering angle quantity deltazist using a vehicle model. Both final values are supplied to block 504.

Although these three determining arrangements 501, 502, and 503 receive the same quantities as input quantities, these determining arrangements contain different vehicle models.

As mentioned previously, quantities Sxg are supplied to determining arrangements 501, 502, and 503. These quantities Sxg are individual quantities such as, for example, the transverse acceleration or the longitudinal acceleration of the tractor vehicle, a friction coefficient quantity, or the estimated wheel forces, based on which the individual final values, primarily the final values for the yaw rate and the buckling angle, are limited to physically plausible values according to the prevailing conditions. For example, the final values for the yaw rate or for the buckling angle are limited, as a function of the transverse acceleration, to such values for which there is no danger of overturning. On the other hand quantities Sxg contain vehicle quantities such as the two mass quantities describing the mass of the tractor vehicle and the semi-trailer, or the two center of gravity position quantities describing the position of the center of gravity for the tractor vehicle and the semi-trailer.

Determining arangements 501, 502, and 503 contain vehicle parameters, such as geometry parameters describing the geometry of the vehicle or tire side rigidity quantities describing the rigidity of the tires used. Both the geometry parameters and the tire side rigidity parameters are determined in advance. Depending on the vehicle quantities supplied to the determining arrangements and on the vehicle parameters, different parameters contained in the vehicle models are determined. The vehicle models are adjusted to the instantaneous load of the vehicle, for example, with this procedure. These vehicle model parameters adjusted in this way include self-steering gradients, for example.

Block 504 represents an adjusting arrangement using which the variation of characteristic quantities omegasolld, betasolld, as well as deltapsisolld over time are adjusted to the vehicle behavior. Using adjusting arrangement 504 the characteristic quantities are determined as a function of the respective final value, i.e., characteristic quantity omegasolld is determined as a function of final value omegasolls, characteristic quantity betasolld is determined as a function of final value betasolls, and characteristic quantity deltapsisolld is determined as a function of final value deltapsisolls. The variations of the characteristic quantities over time are adjusted to the vehicle behavior in adjusting arrangement 504, so that the characteristic quantities attain their respective final value only after a predefined period of time that is characteristic for the vehicle.

Adjusting arrangement 504 is a filter arrangement designed, in particular, as low-pass filters or as all-pass filters or as a PT1 element. The variations of the characteristic quantities over time are influenced by defining a filter constant, which is determined in block 509.

Adjusting arrangement 504 can be used either for adjusting the variations of all characteristic quantities over time to the behavior of the vehicle in the same manner or for adjusting the variation of each individual characteristic quantity over time to the behavior of the vehicle separately. In the first case, the time period is the same for all characteristic quantities, which means that the filter constant provided by block 509 is the same for all characteristic quantities. In the second case the time period for each characteristic quantity is different, which means that a separate filter constant is output by block 509 for each characteristic quantity.

Characteristic quantity omegasolld is supplied from adjusting arrangement 504 to subtracting arrangement 505. The system deviation deltaomega for the yaw rate is determined using subtracting arrangement 505 as a function of characteristic quantity omegasolld and vehicle motion quantity omegaist and supplied to block 508. In a similar manner, characteristic quantity betasolld is supplied to subtracting arrangement 506, and system deviation deltabeta is determined for the float angle as a function of betasolld and vehicle motion quantity betaist and is also supplied to block 508. Characteristic quantity deltapsisolld is also sent to subtractor arrangement 507, and system deviation deltadeltapsi for the buckling angle is determined as a function of deltapsisolld and vehicle motion quantity deltapsiist and is also supplied to block 508.

Block 508 determines quantities deltaMMot and deltaPBrad as a function of the quantities supplied to it, i.e., system deviations deltaomega, deltabeta, and deltadeltapsi, as well as quantities Sy, according to the control implemented in it, and supplies them to actuator system 202. The drive is influenced as a function of quantity deltaMMot and the brakes of the individual wheels are influenced as a function of quantity deltaPBrad. If the driver performs an action, i.e., there is a driver intent in the form of an admission pressure or an engine torque, the quantities generated by controller structure 508 are superimposed on the quantities that represent the driver's intent in block 202. On the other hand, if there is no driver intent, i.e. there is no admission pressure and no engine torque, interventions are only performed as a function of the quantities deltaMMot and deltaPBrad generated by controller structure 508.

Depending on the type of vehicle, a tractor-trailer unit or a single vehicle, the design of controller structure 508 or the control strategy implemented therein may correspond either to the publication “FDR—Die Fahrdynamikregelung von Bosch” [FDR—Vehicle Dynamics Control by Bosch] or to the one described in SAP paper 973284.

The following should be pointed out here: the designation “rad” used for quantities PBrad and deltaPBrad indicates that individual wheels can be influenced individually.

Various actuators are combined in block 202. It contains the brakes associated with the wheels of the tractor vehicle and of the semi-trailer. These can be brakes of a hydraulic, electro-hydraulic, pneumatic, electropneumatic, or electrical brake system. It also contains an arrangement used to influence the drive, i.e., an arrangement for engine interventions. Depending on the type of internal combustion engine, this is an arrangement for influencing the throttle valve angle, the ignition timing, or the amount of injected fuel. Furthermore, the actuators can also contain an arrangement for influencing the steering system. Block 202 may also contain a retarder.

The following should be pointed out here: in general, the characteristic quantities determined using block 302 represent setpoint values needed for control. They are supplied to block 303. Block 303 represents the controller which performs the control as a function of the actual values, i.e., the vehicle motion quantities and the characteristic quantities, determining quantities deltaMMot and deltaPBrad which are supplied to actuator system 202 to perform control interventions.

It has been mentioned previously that block 509 represents a stored characteristic map or a stored table. It is also conceivable that the functional relationship between the velocity of the vehicle and the filter constants or between the mass of the vehicle and the filter constants be determined in advance by test drives and that these relationships be stored in block 509 in the form of functions having linear segments. Thus the filter constants could be determined approximately as a function of the vehicle's velocity or the vehicle's mass during the driving operation.

As long as a microprocessor having sufficient computing power and a sufficiently large memory are available in the controller, the following two methods for computing the filter constants during the driving operation are also conceivable.

The first method analyzes a substantial change in the steering angle, known as a steering angle jump, during driving operation. A first jump response is determined on the basis of the steering angle jump using a reference model. A second jump response is also determined using a linear model. In both cases the jump response represents the yaw rate that sets in as a result of the steering angle jump. The reference model contains the Ackermann relationship and a downstream PT1 element. The linear model also contains the Ackermann relationship, but it contains a second-order downstream element, which allows the actual behavior of the vehicle to be described more accurately. The purpose of the first method is to determine the filter constant of the PT1 element so that the variations of the two jump responses over time coincide as much as possible. The filter constant is determined so that the area enclosed between the two jump responses is minimized. For this purpose, the rectangular area between the two jump responses are determined and its derivative is formed. Using a numerical method, the zero points of the derivative is determined. The positive zero point corresponds to the time constants sought.

The second method is based on the evaluation of the frequency response of the transmission function of the PT1 element of the reference model and of the frequency response of the transmission function of the second-order element of the linear model. The purpose of this method is to determine the limit frequency of the frequency response for the PT1 element so that it coincides with the frequency response of the second-order element. This means that the transmission function of the reference model is adjusted so that its limit frequency is equal to that of the second-order system.

Finally it should be noted that the form of the embodiment selected in the description and the representation selected in the figures should have no restricting effect on the idea that is essential to the present invention.

what is claimed is:

1. A device for stabilizing a vehicle, comprising:
a first determining arrangement for determining at least one vehicle motion quantity describing a motion of the vehicle;
a second determining arrangement for determining a characteristic quantity for the at least one vehicle motion quantity;
a control arrangement for determining intervention quantities as a function of the at least one vehicle motion quantity and the characteristic quantity; and
an actuator arrangement to which the intervention quantities are supplied in order to perform at least one of brake interventions and engine interventions in order to stabilize the vehicle, wherein:
the second determining arrangement includes a computing arrangement for determining a final value for the characteristic quantity,
the final value is supplied to an adjusting arrangement located in the second determining arrangement and for adjusting to a behavior of the vehicle a variation over time according to which the characteristic quantity attains the final value, and
the variation of the characteristic quantity over time is determined using one of a stored characteristic map and a stored table.

2. The device according to claim 1, wherein:
the motion of the vehicle is in a vehicle transverse direction.

3. The device according to claim 1, wherein:
the final value is determined at least as a function of a steering angle quantity describing a steering angle set for the vehicle and a velocity quantity describing a velocity of the vehicle.

4. The device according to claim 1, wherein:
the final value corresponds to a value of the at least one vehicle motion quantity prevailing in a steady state of the vehicle.

5. The device according to claim 1, wherein:
the variation of the characteristic quantity over time is adjusted to the behavior of the vehicle in accordance with the adjusting arrangement so that the characteristic quantity attains the final value only after a predefined period of time that is characteristic for the vehicle.

6. The device according to claim 1, wherein:
the adjusting arrangement corresponds to a filtering arrangement that includes one of low-pass filters, all-pass filters, and a PT1 element, and
the filtering arrangement influences the variation of the characteristic quantity over time by specifying a filter constant.

7. The device according to claim 1, wherein:
a value of the filter constant is read from the one of the stored characteristic map and the stored table as a function of at least one of a mass quantity describing a mass of the vehicle and a velocity quantity describing a velocity of the vehicle.

8. The device according to claim 1, wherein:
the vehicle is a tractor-trailer unit having a tractor vehicle and one of a trailer and a semitrailer, and
at least one of the following is true:
a yaw rate quantity describing a yaw rate of the tractor vehicle is determined as a first vehicle motion quantity,
a float angle quantity describing a float angle of the tractor vehicle is determined as a second vehicle motion quantity, and
a buckling angle quantity describing a buckling angle between the tractor vehicle and the one of the trailer and the semi-trailer is determined as a third vehicle motion quantity.

9. The device according to claim 1, wherein:
the vehicle is a single vehicle, and
at least one of the following is true:
a yaw rate quantity describing a yaw rate of the single vehicle is determined as a first vehicle motion quantity, and
a float angle quantity describing a float angle of the single vehicle is determined as a second vehicle motion quantity.

10. The device according to claim 1, wherein:
a plurality of vehicle motion quantities with respective characteristic quantities are determined, and
the variations of all characteristic quantities over time are adjusted to the behavior of the vehicle in the same manner using the adjusting arrangement.

11. The device according to claim 1, wherein:
the variation of each individual characteristic quantity over time is adjusted to the behavior of the vehicle separately using the adjusting arrangement.

12. The device according to claim 2, wherein:
the final value is determined in accordance with a vehicle model, at least a portion of parameters used in the vehicle model being determined at least as a function of at least one of vehicle quantities and vehicle parameters.

13. The device according to claim 1, wherein:
a plurality of vehicle motion quantities with respective characteristic quantities are determined, and
a value limitation is performed for at least some of respective final values, the limitation being performed in particular as a function of at least one of a transverse acceleration quantity describing a transverse acceleration acting on the vehicle, a longitudinal acceleration quantity describing a longitudinal acceleration acting on the vehicle, a friction coefficient quantity, and wheel force quantities describe forces acting on wheels of the vehicle.

14. A method for stabilizing a vehicle, comprising the steps of:
determining at least one vehicle motion quantity describing a motion of the vehicle;
determining a characteristic quantity for the at least one vehicle motion quantity;
determining intervention quantities as a function of the at least one vehicle motion quantity and the characteristic quantity, the intervention quantities being supplied to an actuator arrangement in order to perform at least one of brake interventions and engine interventions in order to stabilize the vehicle;
determining a final value for the characteristic quantity; and
adjusting to a behavior of the vehicle a variation over time according to which the characteristic quantity attains the final value, wherein:
the variation of the characteristic quantity over time is determined using one of a stored characteristic map and a stored table.
